(19) United States
(12) Patent Application Publication
(10) Pub. No.: US 2010/0024221 A1
(43) Pub. Date: Feb. 4, 2010

(54) HOBBY KNIFE

(75) Inventor: HECTOR RAY HERNANDEZ, FULLERTON, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: ALLTRADE TOOLS LLC, LONG BEACH, CA (US)

(21) Appl. No.: 12/365,011

(22) Filed: Feb. 3, 2009

Related U.S. Application Data
(63) Continuation-in-part of application No. 12/182,802, filed on Jul. 30, 2008.

(51) Int. Cl. B26B 27/00; B26B 1/00

(52) U.S. Cl. 30/296.1; 30/329

(57) ABSTRACT

An axially elongate hobby knife having an external housing defining an internal cavity is described. The hobby knife has structural features that permit the rotation of an rearward actuator. Such rotation causes the blade to withdraw into, or advance from, the cover, thereby to provide for enhanced safety and security of the blade.

This application is a continuation-in-part of application Ser. No. 12/182,802 filed Jul. 30, 2008, which is incorporated herein in its entirety.

### BACKGROUND

This application relates to hobby knives. In particular, the application relates to a hobby knife with a replaceable blade, in which the blade may be withdrawn into the housing of the knife for safety.

Hobby knives are well known in the art. One of the problems with a hobby knife is to secure the blade so that it will not cause harm while the knife is not being used. Some hobby knives provide for a sliding block to hold the blade that the user manually retracts into the housing by sliding the block directly, using a button that moves axially in relation to the knife. Such knives still present a problem however because the button, extending from the profile of the knife, may be inadvertently bumped, causing the blade to extend and to present a hazard.

Thus, there is a need in the art for a hobby knife that allows for easy retraction of the blade without providing an axially moving button on the knife. The present invention addresses these and other needs in the art.

### SUMMARY OF THE INVENTION

According to a preferred embodiment of the invention, there is described a hobby knife configured to address various disadvantages in the prior art.

An axially elongate hobby knife, having an external housing defining an internal cavity, preferably includes a hollow cylindrical cover having a cover forward portion and a cover distal portion, the cover forward portion defining a slot for a blade, and the cover rearward portion having a first external diameter. A hollow cylindrical handle may be positioned distal the cover, the handle having a handle forward portion and a handle distal portion, the handle forward portion having a second internal diameter larger than the first external diameter, the handle forward portion being configured to receive the cover rearward portion, the handle distal portion having a third external diameter. A hollow cylindrical actuator may be positioned distal of the handle, the actuator having a fourth internal diameter larger than the third external diameter, the actuator being configured to receive the handle distal portion. A piston, configured to move axially within the housing cavity, is provided, the piston being axially fixed to the cover whereby axial movement of the piston causes equivalent axial movement of the cover. A first rod may be axially fixed to the piston at one end and extending distally into the actuator so that a distal end of the first rod terminates inside the actuator. A second rod with a distal end that terminates inside the actuator is provided, the second rod extending from said distal end to a forward end that terminates inside the cover, the forward end being axially fixed to a blade holder block positioned inside the cover. The actuator defines an inclined planar surface that is inclined at an angle to the elongate axis of the knife, the planar surface being positioned adjacent the distal end of the first rod and the distal end of the second rod. These features have the advantageous result that, rotation of the actuator causes the inclined planar surface, by contact, to advance and to retract the distal end of the first rod and the distal end of the second rod so that the distal ends axially reciprocate out of phase with one another, and further whereby, the blade holder block and the cover axially reciprocate out of phase with one another.

In another aspect of the invention, the second rod extends through a bore in the piston, whereby the second rod may freely slide through the bore. In a further aspect, a first spring surrounds the first rod. Alternatively, a second spring surrounds the second rod. Further alternatively, a first spring surrounds the first rod, and a second spring surrounds the second rod.

In yet another aspect of the invention, the handle distal portion includes grooves for supporting the first rod and the second rod.

In an additional preferred aspect, the piston defines first external threads, and the cover defines second internal threads configured to mate with the first external threads.

In an even further aspect of the invention, and describing the same aspects of the invention from a different perspective, the invention comprises an axially elongate knife having an external housing defining an internal cavity that includes a hollow cylindrical cover defining, at a forward end of the cover, a slot for a blade. A hollow cylindrical actuator is positioned distal of the cover and is axially rotatable in relation to the cover. A cam surface defined by the knife is provided, the cam surface being inclined at an angle to the knife axis. A piston is provided, configured to move axially within the housing cavity. The piston includes a cam follower configured to engage with and to follow the cam surface when the piston is moved within the housing cavity. A blade holder block is provided that is slideable within the housing cavity. As a result, rotation of the actuator about the knife axis in relation to the cover causes the cam surface, by contact with the cam follower, to either advance or to retract the blade holder block within the housing cavity. This has the advantage that the blade may be withdrawn into the housing for safekeeping.

Preferably, the cam surface is a portion of a generally helical path about the knife axis. Further preferably, the cam surface is a groove defined by an internal wall inside the cavity. In a further aspect, the cam surface may have two end portions and a middle portion, wherein at least one portion has a slope in relation to the axis that is greater than the slope of the middle portion. Again further preferably, the at least one end portion is the end portion that is at a forward end of the groove. This feature allows the piston to effectively “lock” in the open position, so that the blade does not disappear into the knife when pressure is applied to it. In another preferred aspect, the cam surface is defined by an internal wall inside the cavity, and the cam follower is a protrusion attached to the piston. Optionally, the cam follower comprises a short rod attached to the piston.

These and other advantages of the invention will become more apparent from the following detailed description thereof and the accompanying exemplary drawings.

### BRIEF DESCRIPTION OF THE DRAWINGS

FIG. 1 shows a perspective view of a hobby knife having features of the present invention.

FIG. 2 shows a perspective exploded view of the hobby knife of FIG. 1.

FIG. 3 shows a sectional perspective view of a component of the knife of FIG. 1.

FIG. 4 shows a perspective exploded view of some components of the hobby knife of FIG. 1.

FIG. 5 shows a sectional view of the hobby knife of FIG. 1.

FIG. 6 shows an alternative embodiment of a hobby knife having features of the invention.

FIG. 7 shows a perspective exploded view of the hobby knife of FIG. 6.

FIG. 8A shows a sectional view of the hobby knife of FIG. 6.

FIG. 8B is a detail of FIG. 8A, as indicated.

FIG. 9 shows a further perspective exploded view of the hobby knife of FIG. 6.

### DETAILED DESCRIPTION OF THE PREFERRED EMBODIMENTS

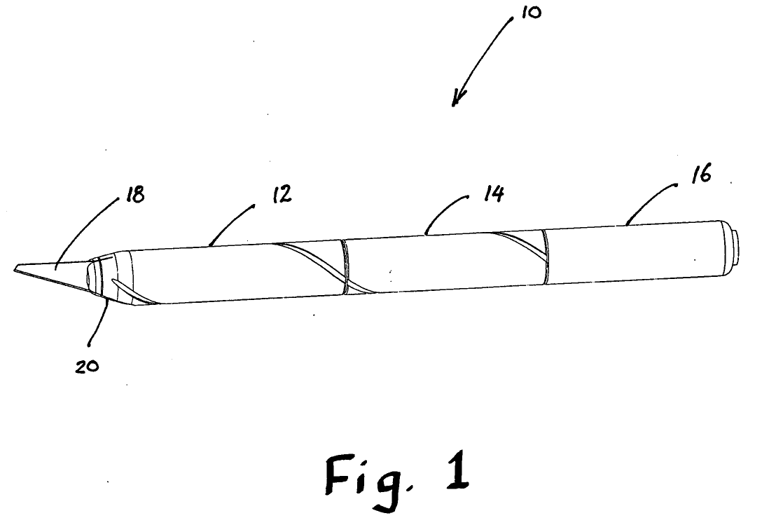

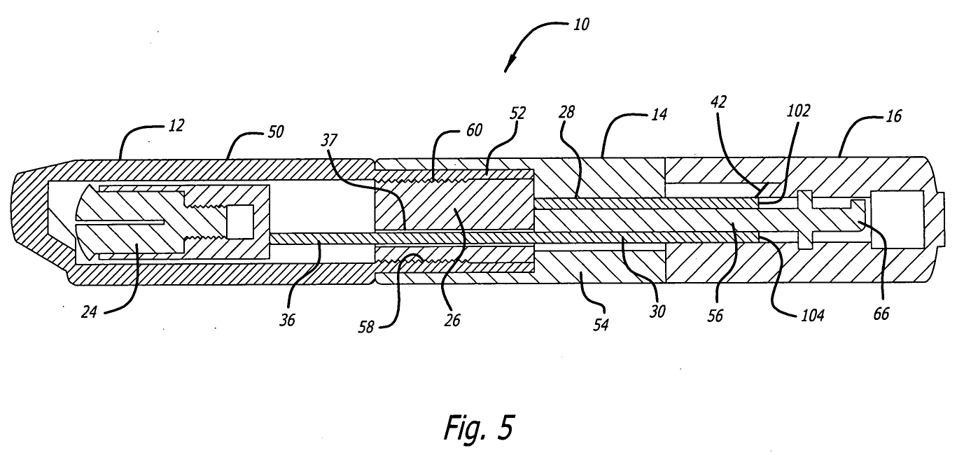

With reference to the drawings, which are shown for exemplification and not limitation, a preferred embodiment of a novel and useful hobby knife is described. FIG. 1 shows a perspective view of a preferred embodiment of the hobby knife, generally referenced by the numeral 10. As may be seen, an outer housing of the knife preferably has a cylindrical form, and defines an inner cavity (FIG. 5). It is preferably divided into three distinct and independent hollow cylindrical components. In the front is a blade cover 12. Behind the cover is a handle 14, and behind the handle is an actuator tube 16. A blade 18 extends from the front end of the blade cover, through a slot 20 in the cover 12.

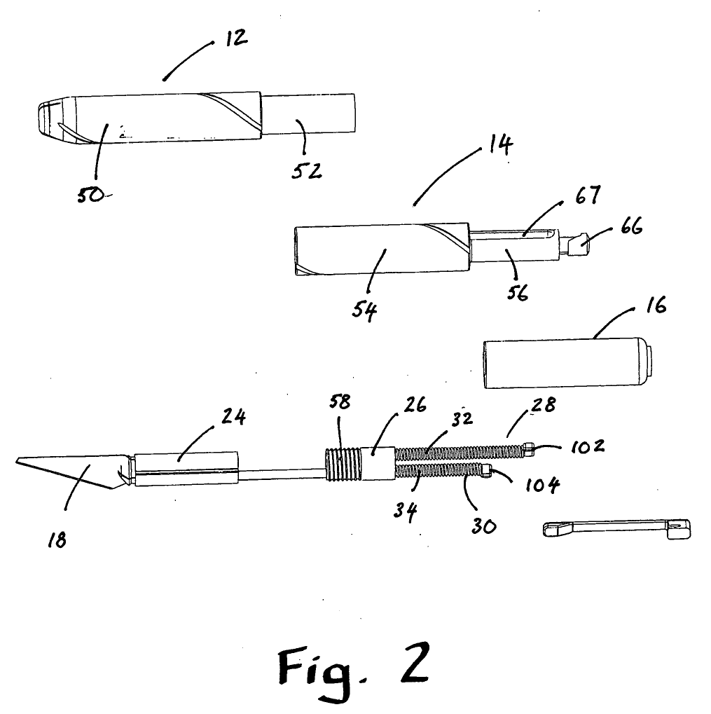

In further detail, as exemplified in FIGS. 2, and 5, the cover 12 preferably has two outer cylindrical portions with different outside diameters. A forward portion 50 has a larger outside diameter than that of a rearward portion 52. Similarly, the handle 14 has a forward portion 54 that has a larger outside diameter than that of a rearward portion 56. The outside diameter of the cover rearward portion 52 is sized to fit within an inside diameter of the handle forward portion 54, as may be seen in FIG. 5. The outside diameter of the handle rearward portion 56 is sized to fit within an inner diameter of the actuator 16 (FIG. 5).

Inside the housing cavity provided by the three external components 12, 14, 16 is situated the working mechanism of the hobby knife. The mechanism includes a piston 26 configured to slide within the cavity of the knife. The piston has an external threaded portion 58 configured to mate with an internal threaded portion 60 of the cover rearward portion 52 (seen in FIG. 5) so that the piston and the cover move axially in unison. The piston 26 also includes two rearward rods 28, 30 extending rearwardly from the rear of the piston, configured to provide an axially reciprocating motion of the piston within the housing cavity, as described below. Extending from the front of the piston is a forward extending reciprocating rod 36, which is a continuation of aligned rearward reciprocating rod 30. Thus, rods 30 and 36 are one continuous rod that slidably extends through a cylindrical bore 37 in the piston (FIG. 5). The adjacent rod 28 is axially fixed to the piston. The rearward portion 56 of the handle may include flutes 67 to stabilize the reciprocating rods 28, 30 (FIG. 2). Each piston rod 28, 30 terminates in a distal end 102, 104.

Attached to the forward end of the forward 36 rod is a conventional blade holder block 24 (FIGS. 5 and 2) that preferably comprises a cylinder split into four portions to be compressed by conventional means for holding the blade 18 securely. The blade holder block 24 may reside within an internal cavity of the blade cover 12 and may slide axially within said internal cavity.

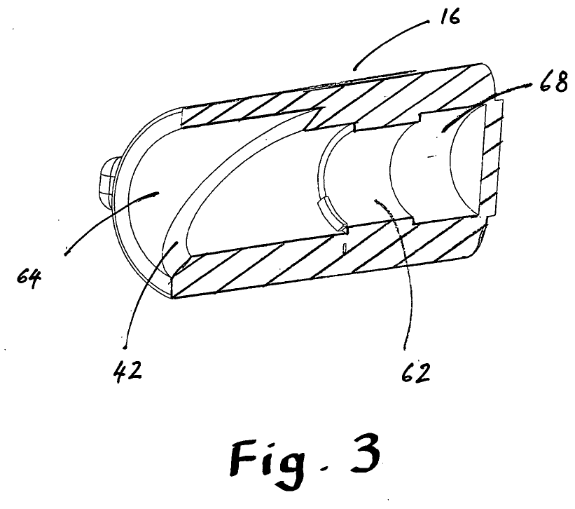

Turning now to FIG. 3, another feature of the invention is described. FIG. 3 shows a perspective sectional view of the actuator 16, in which one half of the actuator is shown. The other half, not shown, is substantially a mirror image of the half that is shown. The hollow cylindrical actuator 16 is preferably positioned at the rear of the knife and is configured to receive the rearward portion 56 of the handle 14 within an inner bore 62. However, forward of this inner bore 62 is a gap portion 64 with a larger bore than that of the inner bore 62. The gap portion is diametrically sized to receive both reciprocating rods 28, 30, so that when the actuator 16 rotates in relation to the handle 14, the actuator rods 28, 30 remain rotationally stationary within the gap portion 64. An important feature of the invention is that to the rearward of the gap portion, an inclined planar surface 42 is machined or molded into the actuator 16, so that rotation of the actuator 16 about the axis of the knife 10 causes the planar surface 42 to rotate in contact with the terminal ends 102, 104 of the reciprocating rods 28, 30. It will be appreciated that rotating the inclined planar surface 42 about the axis of the knife will cause the terminal ends 102, 104 of the reciprocating rods (which are held rotationally stationary by the handle 14) to be forced axially backwards and forwards, thus to oscillate backwards and forwards, or reciprocate, along the length of the device 10. Where the rods 28, 30 are positioned diagonally across the center line of the knife, during such reciprocation the axial movement of the rods will be 180 degrees out of phase with one another. Springs 32, 34 are preferably provided to surround the rods 28, 30 in order to assist in the return motion of the reciprocating action of the rods 28, 30.

It will be appreciated that because rod 28 is axially fixed to the piston 26, and because continuous rod 30, 36 slides through the bore 37 in the piston 26 to connect to the rear end of the blade holder 24, reciprocation of the distal ends 102, 104 of the rods 28, 30 will (a) cause the piston to axially reciprocate (oscillate) in unison with the rod 28, and will (b) also cause the blade holder 24 to axially reciprocate in unison with the rod 30. Because the piston is axially fixed to the cover, the cover will also reciprocate in unison with the rod 28.

In further preferred aspects of the hobby knife, the actuator 16 is configured to rotate in relation to the handle 14, but the actuator 16 is also configured to remain the same axial distance from the handle 14 by virtue of a bulbous stub 66 on the handle that has an outer diameter sized to be rotatably trapped in an internal cavity 68 in the actuator.

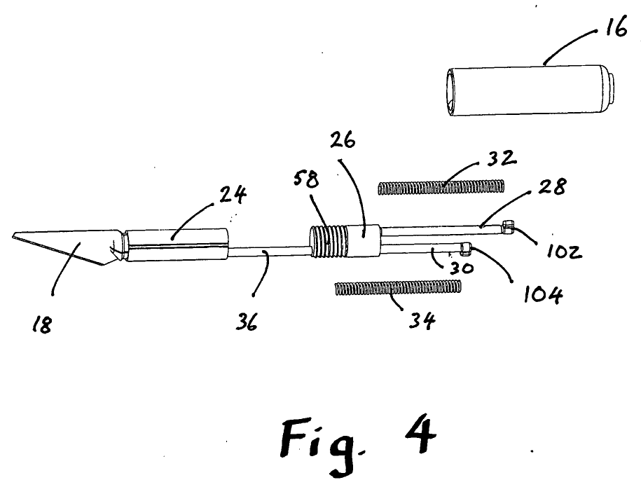

Thus, in use, the user may hold the handle 14 stationary with one hand, and rotate the actuator 16 with the other hand. This action causes the inclined planar surface 42 internal to the actuator to rotate about the knife axis while being positioned adjacent the distal ends 102, 104 of the reciprocating rods 28, 30, thereby causing the rods to reciprocate axially, 180 degrees out of phase with each other. It will be appreciated that this will cause the block 24 to axially reciprocate, and will also simultaneously cause the piston 26 to axially reciprocate 180 degrees out of phase with the block, with the continuous rod 28, 36 sliding through the bore 37 in the piston. Reciprocation is assisted by the presence of two springs, a first spring 32 surrounding the first rod 28, and a second spring 34 surrounding the second rod 30, as seen in FIGS. 2 and 4. As seen in FIG. 5, the internal threads 60 on the cover 12 are mated with the external threads 58 on the piston 26. It follows that the piston 26 and the cover 12 (being axially fixed to each other) will axially reciprocate in unison with each other, and accordingly, that the block 24 (with its blade 18) and the cover 12 will axially reciprocate 180 degrees out of phase with each other.

The cover 12 is able to axially reciprocate in relation to the handle 14 because the rearward portion 52 of the cover is able to slide back and forth within the forward portion 54 of the handle without disengagement and without obstruction from the handle. This action has the result that, when a user holds the handle 14 with one hand, and rotates the actuator 16 with the other hand, the blade 18 and the cover 12 axially reciprocate out of phase with each other. This has the advantageous effect that, rotation of the actuator 16 causes the blade 18 to withdraw into the cover 12 through the slot 20 at the same time as the cover 12 is axially advanced over the blade 18, effectively doubling the relative speed with which the blade would otherwise be covered. This action advantageously provides for greater security in storing the blade 18 within the housing cavity because a small manual action in which the actuator is rotated causes both retraction of the blade 18 into the cover 12, and advancement of the cover over the blade at the same time. It will be appreciated that continued rotation of the actuator will cause the blade 18 to advance out of the cover 12 at the same time as the cover is withdrawn from the blade.

In order to exchange the blade when its edge has become dull, the user may retract the blade 18 through the slot 20 into the cover 12 by rotating the actuator 16 an appropriate amount as described above. The user may then hold the handle 14 stationary with one hand, and twist the cover 12 with the other hand to disengage the external threads 58 of the piston 26 from the internal threads 60 of the cover 12. The cover is removed from the knife 10 to expose the blade holder block 24. By conventional means, the blade 18 may be released from being gripped in the block and may be replaced by another blade. The cover 12 is then reinstalled on the knife by reversing the steps above, and the cover threads 60 are screwed onto the threads 58 of the piston 26 by an amount that will permit the blade 18 to be aligned with the slot 20 so that the blade may extend from the slot when the actuator 16 is rotated.

Thus, in use, the operation of the components of the knife may be summarized thus:

When the handle 14 is held rotationally stationary and the actuator 16 is rotated, the cover 12 and the handle 14 are constrained by their geometry to not rotate in relation to one another. Rather, under this action, the cover 12 axially reciprocates back and forth in relation to the handle 14, with the rearward end 52 of the cover sliding back and forth within the forward end 54 of the handle.

Furthermore, when the handle 14 is held rotationally stationary and the actuator 16 is rotated, the handle 14 and the actuator 16 rotate in relation to one another, but are constrained by their geometry to be held axially fixed in relation to each other. Under this action, the rotation of the actuator causes the inclined planar surface 42 to rotate about the knife axis adjacent the terminal ends 102, 104 of rods 28, 30 and, by contact, forces the terminal ends to reciprocate, preferably 180 degrees out of phase with one another. Reciprocation is assisted by springs 32, 34 mounted on the rods to restore the rods to a position in contact with the inclined planar surface 42 as the surface rotates about the axis of the knife. Reciprocation of rod 28 causes reciprocation of the piston 26 within the housing of the knife, and this in turn causes reciprocation of the cover 12 in relation to the handle 14, because the piston is threadably fixed to the cover. Reciprocation of rod 30 causes reciprocation of rod 36 (rod 30 and rod 36 are in fact one single continuous rod), and this reciprocation of combined rod 30, 36 causes the blade holder block 24 to reciprocate out of phase with the reciprocation of the assembly comprising rod 28, piston 24, and cover 12. Notably, rod 30, 36 preferably slides through a bore 37 in the piston 26, thereby allowing the two reciprocating actions to take place freely and out of phase.

For removing and replacing the blade, after the blade is withdrawn into the cover, the handle 14 may be held rotationally stationary, and the cover 12 may be rotated to disengage threads 58 and 60 from each other so that the cover may be removed from the knife for replacing the blade.

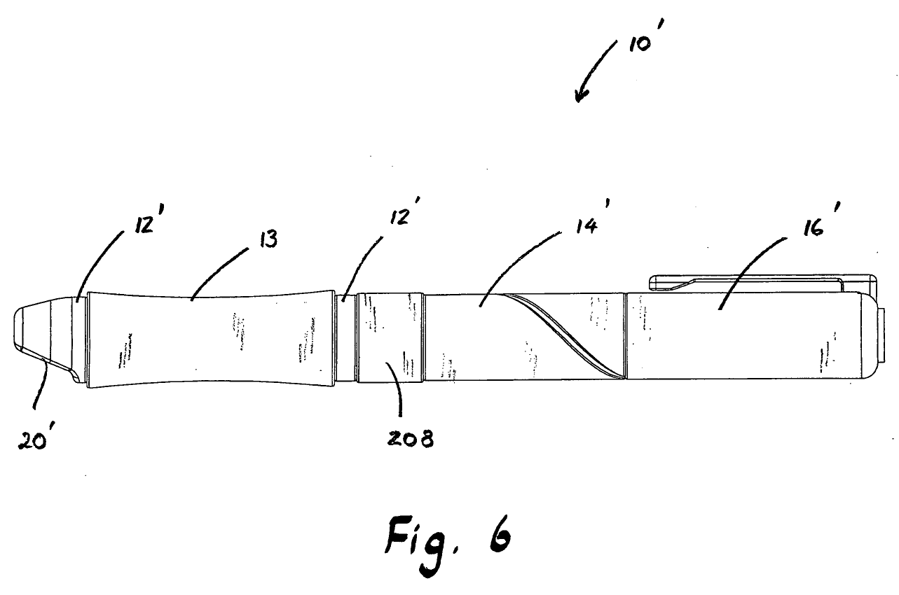

A second embodiment of the above invention is now disclosed, with reference to FIGS. 6 -8. In this embodiment, the external cylindrical structure of the invention includes a blade cover 12′, a handle 14′, and an actuator tube 16′, with the handle being disposed between the blade cover and the actuator tube, as in the previous embodiment. A collar 208 may be interposed between the cover 12′ and the handle 14′ for connecting the cover to the handle. The blade cover 12′ may include an external rubberized grip 13 moving in unison with the cover, to enhance frictional contact with the cover by a user.

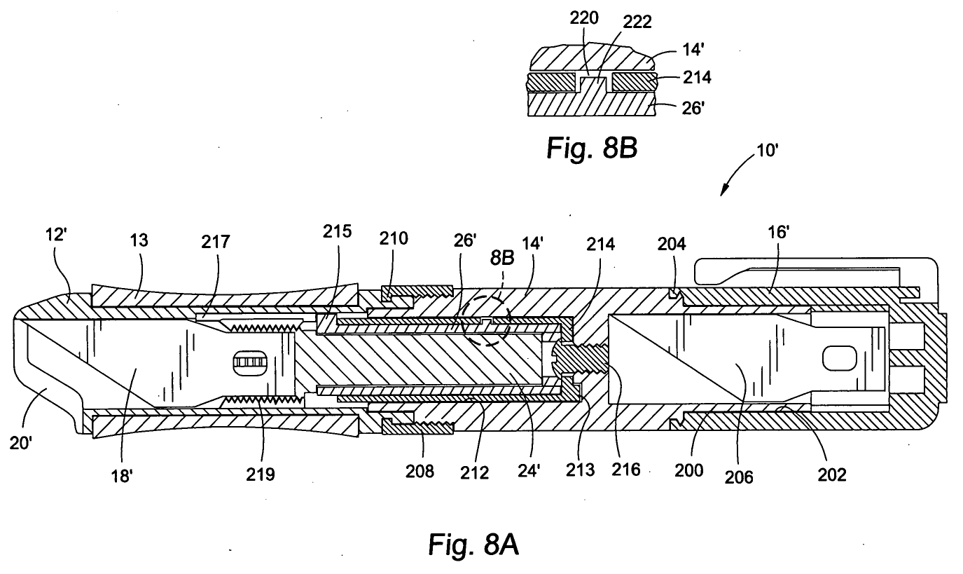

In the present embodiment, the actuator 16′ and the handle 14′ are configured to act in unison with each other (i.e., to move together both axially and rotationally.) To this end, the handle includes a rectangular portion 200 configured to fit within a mating hollow rectangular cylinder 202 (FIG. 8) in the handle. Thus, when the actuator 16′ is rotated, the handle 14′ follows with the same rotation. Further, the actuator 16′ may be axially clipped onto the handle 14′ via detents 204 (FIG. 8), so that the actuator follows the handle axially, and thus the actuator moves in unison with the handle. The actuator may be unclipped from the handle to reveal a storage space where spare blades 206 may be kept.

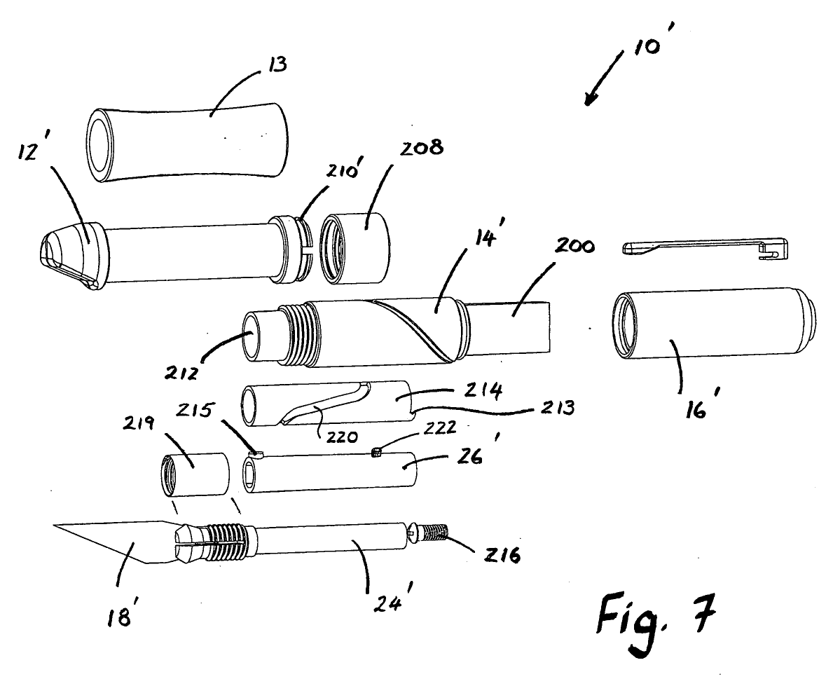

The forward end of the handle 14′ is threaded to receive a threaded collar 208. The forward end of the collar includes detents 210 (FIG. 8) for attachment to mating detents 210′ (FIG. 7) on the distal end of the blade cover 12′. Thus, the handle 14′ follows the blade cover 12′ axially. However, the handle and blade cover are free to rotate in relation to each other about detents 210 and 210′.

The handle 14′ includes an internal cylindrical chamber 212 (FIG. 7, 8). Inside the chamber 212, a hollow cam cylinder 214 is snugly positioned (FIG. 8). The cam cylinder 214 is fixed to the handle 14′ by means of a screw 216, and a foot 213 (FIG. 7, 8) on the cam cylinder engages with a mating foot on the handle, so that the cam cylinder 214 and handle 14′ effectively move in unison (i.e., the move together both rotationally and axially). Inside the hollow cam cylinder 214 is positioned a piston 26′ with a cylindrical outer surface shaped to rotate within the hollow cam cylinder 214. The cam cylinder includes a groove 220, or cam surface, extending about an inner surface. The groove may extend through and penetrate the outer wall of the cam cylinder 214, as shown in FIG. 7. The groove 220 is desirably generally helical in form, and may extend around only part of the cam surface cylinder—as more fully described below. The piston 26′ includes a first protrusion 222, or cam follower, on an outer surface of the piston, the first protrusion being configured to fit within the groove 220, and to slide along the groove. Thus, if the cam cylinder 214 is rotated about the piston 26′, the first protrusion 222 is compelled to slide along the generally helical groove 220. It will be appreciated that this action will compel the piston to move axially in relation to the cam cylinder 214 (and hence in relation to the handle 214, to which the cam cylinder is fixed by screw 216 and foot 213). A second protrusion 215 is also positioned on the outside surface of the piston 26′. This second protrusion is configured to slide within a linear slot 217 (FIG. 8) in the internal surface of the blade cover 12′. Thus, the piston and the blade cover 12′ are configured to allow axial motion in relation to each other, but rotation relative to each other is denied by the interaction of the second protrusion 215 with the linear slot 217.

Inside the piston 26′ is positioned a blade holder block 24′ configured to hold the blade 18′ as in the previous embodiment. The blade holder block is shaped with a non circular cross section, and is thus configured to act in unison with the piston 26′, so that any movement (axial or rotational) of the piston is followed by the same movement of the blade holder block and by the blade. A threaded collar 219 is provided to compressively lock the blade 18′ onto the lock bar 24′.

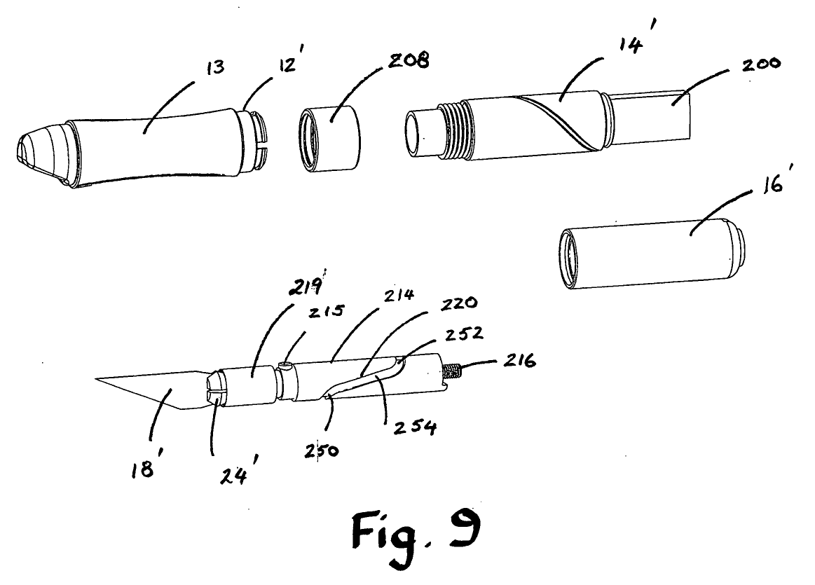

Returning to a fuller description of the groove 220, the groove has two end portions 250, 252 and a middle portion 254 (FIG. 9). The end portions 250, 252 are desirably provided with a gradient or slope in relation to the axis of the knife that is greater than the gradient of the middle portion 254. This feature provides the advantage that, when the first protrusion 222 is located in one of the end portions (specifically, the forward end portion of the groove 250), then a force applied to the blade holder block axially along the knife will not tend to cause the blade holder block to move axially into the knife. Rather, axial linear movement of the blade holder block into the knife is impeded by the high gradient of the groove 220 interacting with the protrusion 222. Thus, in use of the knife, a user may apply a considerable pressure to the blade without the blade disappearing into the cavity of the knife. However, this feature does not prevent the user from intentionally retracting the blade into the knife by a manual rotational action, as described below.

One of ordinary skill will appreciate that the elements “cam surface” and “cam follower” stated herein are interchangeable, in that the two elements in combination with each other will produce linear movement by the piston when a rotational movement is provided to the actuator, in relation to the cover, and vice versa. Thus, the present invention contemplates that if the two elements “cam surface” and “cam follower” are interchanged with each other, the resulting structure still falls within the scope of the invention.

Thus, in use, the second embodiment of the invention is activated as follows. A user grasps the blade cover 12′ (by the rubberized grip 13, if such is provided) with one hand. Then, with the other hand, the user grasps either the handle 14′ or the actuator 16′ (these latter two components moving in unison) and twists one hand in relation to the other. It will be appreciated that by doing so, the cam cylinder 214 is rotated in relation to the piston 26′. If the piston 26′ is already in a retracted position within the cam cylinder 214, this twisting action will cause the cam follower 222 to slide in the cam surface (or, groove) 220 of the cam cylinder, thus causing the piston 26′ to advance forwardly, thereby causing the blade holder block 24′ and its blade 18′ to advance, and thus allowing the blade to protrude through a slot 20′ in the cover 12′. Conversely, if the blade is already protruding through the slot 20′, then by twisting his hands the other way, a user may cause the blade to be retracted into the blade cover 12′ by a converse action of the elements. The interaction of the cam follower 222 on the piston 26′ sliding along the cam surface 220 in the cam cylinder 214 compels the blade to advance and retract, according to the desire of the user and the direction that he twists the actuator 16′ in relation the cover 12′.

Thus, this second embodiment provides a similar result to the first embodiment, wherein rotation of one external part of the knife in relation to another external part of the knife causes the knife blade to advance or retract into the knife, thereby providing a safe solution to the problems described above.

Thus, it is seen that the hobby knife of the present invention provides novel and useful features for overcoming shortcomings in the prior art. The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

We claim:

1. An axially elongate knife having an external housing defining an internal cavity, comprising:
a hollow cylindrical cover defining, at a forward end of the cover, a slot for a blade;
a hollow cylindrical actuator positioned distal of the cover, the actuator being axially rotatable in relation to the cover, while being axially linearly fixed in relation to the cover;
a cam surface defined on an internal wall of the cavity, the cam surface being inclined at an angle to the knife axis;
a piston configured to move axially within the housing cavity, the piston including a cam follower configured to engage with and to follow the cam surface when the piston is moved within the housing cavity;
a blade holder block slideable within the housing cavity and connected to the piston so that the blade holder moves in unison with the piston;
whereby rotation of the actuator about the knife axis in relation to the cover causes the cam surface, by contact with the cam follower, to either advance or to retract the blade holder block within the housing cavity.

2. The knife of claim 1, wherein the cam surface is a portion of a generally helical path about the knife axis.

3. The knife of claim 2, wherein the cam surface is a groove defined by an internal wall inside the cavity.

4. The knife of claim 3, wherein the cam follower is a protrusion attached to the piston and is configured to slide within the groove.

5. The knife of claim 1, wherein the cam surface has two end portions and a middle portion, wherein at least one portion has a slope in relation to the axis that is greater than the slope of the middle portion.

6. The knife of claim 5, wherein the at least one end portion is the end portion that is at a forward end of the groove.

7. The knife of claim 1, the knife further including a cam cylinder surrounding the piston, the cam cylinder being removable from the knife during disassembly of the knife, wherein the cam cylinder defines the cam surface.

8. The knife of claim 7, wherein the cam cylinder is attached to the handle by a screw.

9. The knife of claim 1, wherein the knife further includes a removable distal portion with a hollow cavity configured to receive and store spare blades for the knife.

10. An axially elongate knife having an external housing defining an internal cavity, comprising:
a hollow cylindrical cover defining, at a forward end of the cover, a slot for a blade;
a hollow cylindrical actuator positioned distal of the cover and axially rotatable in relation to the cover;
a cam surface defined by the knife, the cam surface being inclined at an angle to the knife axis;
a piston configured to move axially within the housing cavity, the piston including a cam follower configured to engage with and to follow the cam surface when the piston is moved within the housing cavity;
a blade holder block slideable within the housing cavity;
whereby rotation of the actuator about the knife axis in relation to the cover causes the cam surface, by contact with the cam follower, to either advance or to retract the blade holder block within the housing cavity.

11. The knife of claim 10, wherein the cam surface is a portion of a generally helical path about the knife axis.

12. The knife of claim 11, wherein the cam surface is a groove defined by an internal wall inside the cavity.

13. The knife of claim 11, wherein the cam surface has two end portions and a middle portion, wherein at least one portion has a slope in relation to the axis that is greater than the slope of the middle portion.

14. The knife of claim 13, wherein the at least one end portion is the end portion that is at a forward end of the groove.

15. The knife of claim 10, wherein the cam surface is defined by an internal wall inside the cavity.

16. The knife of claim 10, wherein the cam follower is a protrusion attached to the piston.

17. The knife of claim 10, wherein the cam follower comprises a rod attached to the piston.
